(19) United States
(12) Patent Application Publication
(10) Pub. No.: US 2011/0273109 A1
(43) Pub. Date: Nov. 10, 2011

(54) Organic light emitting display and method of driving the same

(76) Inventor: Sung-Cheon Park, Yongin-City (KR)

(21) Appl. No.: 13/064,432

(22) Filed: Mar. 24, 2011

(30) Foreign Application Priority Data
May 10, 2010 (KR) 10-2010-0043502

(51) Int. Cl. H05B 37/02

(52) U.S. Cl. 315/291

(57) ABSTRACT

An organic light emitting display includes a pixel unit including pixels coupled to scan lines and data lines, a DC-DC converter for transmitting a voltage level of at least one power source of a first power source and a second power source to provide the power source to the pixel unit, and a voltage controller for controlling a voltage level transition time of the DC-DC converter. A method of driving such an organic light emitting display may include converting an input voltage into a predetermined first voltage level of a driving power source, adjusting the first level voltage of the driving power source to a second level voltage, wherein the second level voltage reaches a steady state, and applying black data to a pixel unit during a time period when the first level voltage is being adjusted to the second level voltage.

### BACKGROUND

1. Field

Embodiments relate to an organic light emitting display, and more particularly, to an organic light emitting display in which voltage levels of driving power sources are adjusted and a method of driving the same.

2. Description of the Related Art

Recently, various flat panel displays (FPD) capable of reducing weight and volume that are disadvantages of cathode ray tubes (CRT) have been developed. FPDs include liquid crystal displays (LCDs), field emission displays (FEDs), plasma display panels (PDPs), and organic light emitting displays.

Among the FPDs, the organic light emitting displays display an image using organic light emitting diodes (OLED). The OLED includes an anode electrode, a cathode electrode, and a light emitting layer. The light emitting layer is positioned between the anode electrode and the cathode electrode and emits light when current flows from the anode electrode to the cathode electrode to display a color. The organic light emitting displays employ such OLEDs, which are self-emissive elements.

Organic light emitting display devices are widespread in the market in a variety of products and applications, e.g., personal digital assistant (PDAs), MP3 players, mobile telephones due to various advantages such as excellent color reproducibility and small thickness. Improved organic light emitting display devices, e.g., more power efficient organic light emitting display devices, are still desired.

### SUMMARY

Embodiments are therefore directed to organic light emitting display devices, which substantially overcome one or more of the problems due to the limitations and disadvantages of the related art.

It is therefore a feature of an embodiment to provide an organic light emitting display in which driving power sources are adjusted to be applied and black data is displayed during a period corresponding to a driving power source transition time in order to prevent picture quality from deteriorating when the driving power sources are adjusted and a method of driving the same.

It is therefore a separate feature of an embodiment to provide an organic light emitting display device in which driving power sources are adjusted such that power consumption may be reduced.

It is therefore a separate feature of an embodiment to display black data during a driving power source transition time so that it is possible to reduce and/or eliminate picture quality deterioration.

At least one of the above and other features and advantages may be realized by providing an organic light emitting display, including a pixel unit including pixels coupled to scan lines and data lines, a DC-DC converter for transmitting a voltage level of at least one power source of a first power source and a second power source to provide the power source to the pixel unit, and a voltage controller for controlling a voltage level transition time of the DC-DC converter.

The first power source may have a high level voltage value.

The first power source may be applied as a predetermined first level voltage value and is adjusted into a second level voltage value after a time controlled by the voltage controller.

The second power source may have a low level voltage value.

The second power source may be applied as a predetermined first level voltage value and may be adjusted to a second level voltage value after a time controlled by the voltage controller.

The first power source may reach a second level voltage value by the voltage controller at a time when the DC-DC converter is turned on.

The second power source may reach a second level voltage value by the voltage controller at the time when the DC-DC converter is turned on.

The DC-DC converter may include first and second coils, first and second switching elements adapted to control current to and/or from the first and second coils, respectively, a reference voltage transition circuit adapted to adjust a reference voltage level, a pulse-width modulated (PWM) controller adapted to control switching operations of the first and second switching elements, and first and second resistors coupled between the first reference voltage transition circuit and the second coil.

The first switching element may be adapted to transmit input current to the first coil to control generation of electromotive force by the first coil.

The PWM controller may include a lookup table in which a voltage correction range of the reference voltage level corresponding to the voltage level of the input current is provided.

The first switching element and the second switching element may be coupled in parallel.

The PWM controller may be coupled between the first and second resistors and the reference voltage transition circuit.

At least one of the above and other features and advantages may be separately realized by providing a method of driving an organic light emitting display, including adjusting an input voltage into a predetermined first voltage level of a driving power source, adjusting the first level voltage of the driving power source to a second level voltage, wherein the second level voltage reaches a steady state, and applying black data to a pixel unit during a time period when the first level voltage is being adjusted to the second level voltage.

The driving power source may be a high level first power source.

The driving power source may be a low level second power source.

An absolute value of the second level voltage value may be larger than an absolute value of the first level voltage value.

Applying black data may include applying black data to the pixel unit during each frame period during which adjusting the first level voltage of the driving power source to the second level voltage takes place.

Applying black data may include applying black data during three continuous frame periods.

A driving frequency of the frame may be 60 Hz.

At least one of the above and other features and advantages may be separately realized by providing a method of driving an organic light emitting display, including adjusting an input voltage into an initial voltage level of a driving power source, the initial level voltage reaching a steady state, and applying black data to a pixel unit during a frame period during which the input voltage is adjusted into the initial voltage level.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an organic light emitting display according to an embodiment of the present invention;

FIG. 2 illustrates a circuit diagram of an exemplary DC-DC converter employable by the organic light emitting display illustrated in FIG. 1;

FIG. 3A illustrates a diagram of an embodiment of a driving method when a second power source ELVSS is adjusted;

FIG. 3B illustrates a diagram of another embodiment of a driving method when the second power source is adjusted;

FIG. 4A illustrates a diagram of an embodiment of a driving method when a first power source ELVDD is adjusted;

FIG. 4B illustrates a diagram of a second embodiment of a driving method when the first power source ELVDD is adjusted;

FIG. 5A illustrates a diagram of an other embodiment of a driving method when the second power source ELVSS is adjusted;

FIG. 5B illustrates a diagram of another embodiment of a driving method when the first power source ELVDD is adjusted; and

FIG. 6 illustrates a graph of a relationship between saturation point and an amount of current of an organic light emitting diode (OLED).

### DETAILED DESCRIPTION

Korean Patent Application No. 10-2010-0043502, filed on May 10, 2010, in the Korean Intellectual Property Office, and entitled: “Organic Light Emitting Display and Driving Method Thereof” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements may be exaggerated for clarity of illustration. It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout the specification.

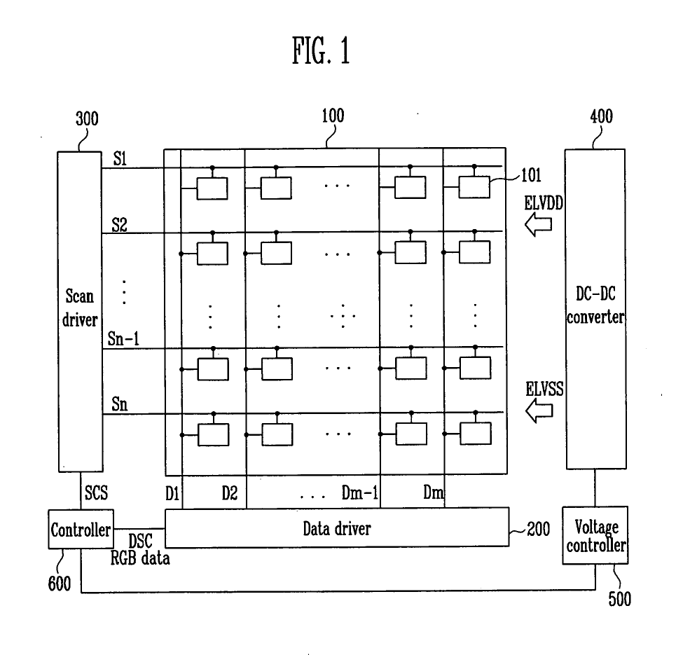

FIG. 1 illustrates a block diagram of an organic light emitting display according to an embodiment of the present invention.

Referring to FIG. 1, the organic light emitting display may include a pixel unit 100 including pixels 101 coupled to scan lines S1 to Sn and data lines D1 to Dm, a scan driver 300 for supplying scan signals to the pixels 101 through the scan lines S1 to Sn, a data driver 200 for providing data signals to the pixels 101 through the data lines D1 to Dm, a DC-DC converter 400 for adjusting the voltage level of a first power source ELVDD and/or a second power source ELVSS to provide the voltage level of the first power source ELVDD, e.g., relatively high voltage level, and/or the second power source ELVSS, e.g., relatively low voltage level, to the pixel unit 100, a voltage controller 500 for controlling the voltage level transition time of the DC-DC converter 400, and a controller 600 for controlling the scan driver 300, the data driver 200, and the voltage controller 500.

In the exemplary embodiment of FIG. 1, the plurality of pixels 101 are arranged in the pixel unit 100 and each of the pixels 101 includes an organic light emitting diode (OLED) (not shown) for emitting light to correspond to the flow of current. In the pixel unit 100, n scan lines S1, S2, . . . , Sn-1, and Sn formed in a first direction to transmit the scan signals and m data lines D1, D2, . . . , Dm-1, and Dm formed in a second direction to transmit the data signals are arranged.

The pixels 101 may receive power from driving power sources, e.g., the high level first power source ELVDD and the low level second power source ELVSS to be driven. Therefore, in the pixel unit 100, currents may flow to the OLEDs based on the scan signals, the data signals, the first power source ELVDD, and the second power source ELVSS so that light may be emitted and an image may be displayed.

The data driver 200 may generate data signals to apply the generated data signals to the pixels 101, and may generate image signals R, G, and B data having red, blue, and green components and the data signals using a control signal DSC applied by the controller 600. The data driver 200 may apply the data signals generated through the data lines of the pixel unit 100 to the pixels 101.

The scan driver 300 may generate the scan signals using a control signal SCS applied by the controller 600 to apply the generated scan signals to the pixels and may sequentially apply the scan signals to the plurality of scan lines S1, S2, . . . , Sn-1, and Sn. The data signals output from the data driver 200 may be transmitted to the pixels 101 to which the scan signals are applied so that voltages corresponding to the data signals may be transmitted to the pixels.

The DC-DC converter 400 may receive an externally input voltage and may generate the first power source ELVDD voltage level and the second power source ELVSS voltage level for driving the pixel unit 100 and may apply the generated first power source ELVDD and second power source ELVSS to the pixel unit 100.

The DC-DC converter 400 may receive command signals from a voltage controller 500 to adjust the voltage levels of the first and/or second power sources and to provide the respective voltage levels. The voltage controller 500 may control the voltage level transition time of the DC-DC converter 400 through the control signals applied by the controller 600. For example, the DC-DC converter 400 may receive an input voltage from a battery (not shown) to generate the first power source ELVDD voltage level and the second power source ELVSS voltage level.

The DC-DC converter 400 may include a boost circuit for generating the high level first power source ELVDD voltage level and a buck boost circuit for generating the low level second power source ELVSS voltage level. That is, the DC-DC converter 400 may include the boost circuit and/or the buck boost circuit to generate the first and second power source voltage levels. More particularly, e.g., the boost circuit may boost the input voltage to generate the first power source ELVDD and the buck boost circuit may reduce the input voltage to generate the second power source ELVSS. The smaller the difference between the input voltage and the output voltage, the more effective the boost circuit and the buck boost circuit may be. However, e.g., the input voltage applied from the battery may gradually decrease as time passes, and such a boost circuit and/or buck boost circuit may not generate the intended first and/or second power source voltage levels. That is, when the input voltage is reduced, a difference between the input voltage and the output voltage output from the DC-DC converter 400 may increase, and the boost circuit and/or the buck boost circuit may not be as effective in generating the first and/or second power source voltage levels.

Embodiments of the DC-DC converter 400 may be adapted to transition the voltage levels of the output first power source ELVDD and/or second power source ELVSS and at least partially and/or completely accommodate for changes in the input voltage and/or input current as a result of, e.g., temperature, battery life, etc. For example, in embodiments, the voltage controller 500 may determine changes in the input voltage and/or input current and may transmit a command signal to the DC-DC converter 400 in order to adjust the voltage levels of the first power source ELVDD and/or the second power source ELVSS.

More particularly, e.g., when the input voltage applied through a battery (not shown) is reduced, the voltage controller 500 may sense a reduction in the input voltage and may transmit a command signal to the DC-DC converter 400 corresponding to the level of the sensed input voltage to adjust the voltage levels of the first power source ELVDD and/or the second power source ELVSS.

Since the output voltage may be controlled corresponding to the input voltage of the boost circuit and the buck boost circuit, the effectiveness of the DC-DC converter 400 may increase.

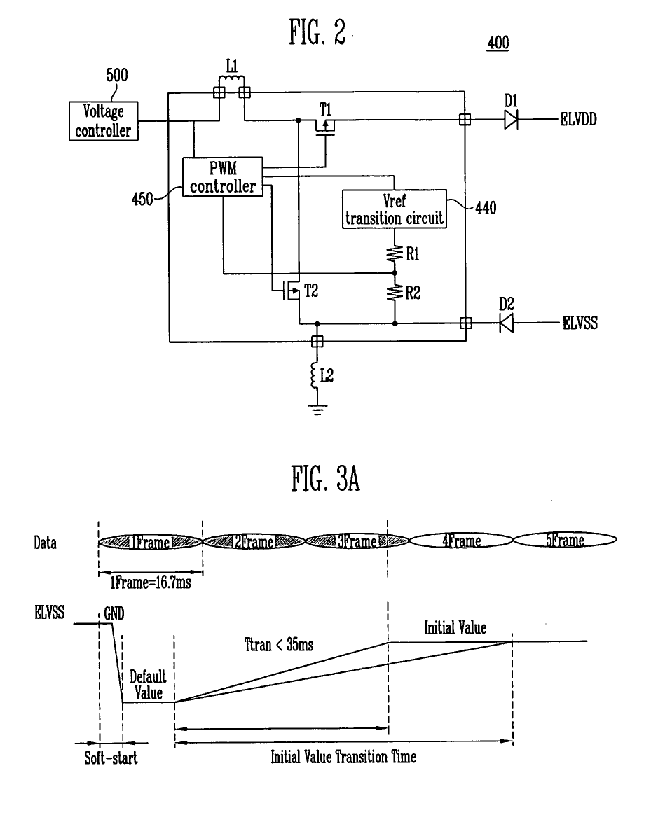

FIG. 2 illustrates a circuit diagram of an exemplary embodiment of the DC-DC converter 400 of FIG. 1. More particularly, in FIG. 2, an exemplary structure of the DC-DC converter 400 that is adapted to adjust the voltage level of the second power source ELVSS is illustrated. However, those skilled in the art would appreciate that the voltage level of the first power source ELVDD may be adjusted through the same structure.

Referring to FIG. 2, the DC-DC converter 400 may include a first coil L1 for generating electromotive force in accordance with changes, e.g., increase, reduction, etc., in input current to boost the voltage level of the input current, a first switching element T1 for transmitting the input current to the first coil L1 or blocking the input current from the first coil L1 so as to control generation of electromotive force by the first coil L1, a second switching element T2 coupled to the first switching element T1 in parallel to transmit or block the flow of the input current transmitted through the first coil L1, a second coil L2 serially coupled to the second switching element T2 to generate electromotive force by transmitting or blocking the input current transmitted through the second switching element T2, a reference voltage Vref transition circuit 440 for adjusting a reference voltage Vref, first and second resistors R1 and R2 coupled between the reference voltage Vref transition circuit 440 and the second coil L2 to perform voltage distribution and to generate the second power source ELVSS voltage, and a PWM controller 450 for controlling the switching operations of the first and second switching elements T1 and T2.

The PWM controller 450 may be coupled between the first resistor R1 and the second resistor R2 and may enable the distributed voltage to be feedback. The reference voltage Vref may be controlled by the reference voltage Vref transition circuit 440.

The reference voltage Vref transition circuit 440 may receive a predetermined voltage to adjust the voltage level, for example, through voltage distribution.

The PWM controller 450 may include a lookup table (not shown) in which a voltage correction range of the reference voltage Vref corresponding to the voltage level of the input current sensed by the voltage controller 500 is designated. Therefore, when the voltage level of the input voltage sensed by the voltage controller 500 is determined, the PWM controller 450 may correct the reference voltage Vref using the lookup table. Therefore, the voltage of the second power source ELVSS may be determined based on the corrected reference voltage Vref.

In driving the exemplary embodiment of the DC-DC converter 400, the input voltage, e.g., GND, may be driven by the first power source ELVDD or the second power source ELVSS having a previously set voltage level (default value, a first level, etc.) through a soft-start operation and may be adjusted to the first power source ELVDD or the second power source ELVSS having a new voltage level (an initial value, a second level, etc.) by controlling the built-in resistance values R1 and R2 of the DC-DC converter 400 and by correcting the reference voltage Vref.

That is, according to the embodiment of the present invention, the DC-DC converter 400 may carry out multiple operations. For example, when an enable signal is input to the DC-DC converter 400, the DC-DC converter 400 may convert the input voltage into the previously set voltage level, e.g., default value, the first level, etc. When the command signal is input from the voltage controller 500 to the DC-DC converter 400 to adjust the voltage, the DC-DC converter 400 may transition the output signal to have the new voltage level, e.g., the initial value, the second level, etc. When the IC integrated with the DC-DC converter 400 is shut down, the voltage may be stably driven.

In another operation, e.g., when the enable signal is input to the DC-DC converter 400 and the command signal is input from the voltage controller 500, the DC-DC converter 400 may output the voltage of the second level without initially converting the input voltage to the previously set voltage, e.g., the first level.

Among the above methods, in order to carry out the second operation, e.g., adjust the voltage level to the second level, e.g., a desired voltage level, based on the command signal applied from the voltage controller 500, a uniform logic in the IC must be turned on during the IC shut down.

In addition, when the voltage level of the first power source ELVDD or the second power source ELVSS is adjusted from the first level into the second level, after the second level reaches a steady state, the display may be realized.

When adjusting the first level into the second level occurs rapidly, noise in accordance with a change in the driving power source applied to the pixel unit may be represented as a screen defect.

However, since time for which the first level is adjusted so that the second level reaches the steady state, that is, the transition time may not be controlled by the DC-DC converter 400, in view of the potential screen defect, the display may be driven so that valid image data is not displayed during a transition period.

The transition time may be proportionate to (V1−V2)*C/I_{load}, where V1: the default value, the first level, etc.; V2: the initial value, the second level, etc.; C: output capacitance of the DC-DC converter 400; and I_{load}: output current of the DC-DC converter 400.

That is, transition time may increase as a difference between the first level and the second level is larger, the value of the output capacitance is larger, and/or the value of the output current is smaller.

In some embodiments, to avoid noise being reflected on the display screen as a result of, e.g., the transition time for adjusting the voltage level, during the transition period, black data may be displayed to prevent picture quality from deteriorating. For example, in the case of a display applied to a mobile apparatus and a transition time about 30 ms to 35 ms, to avoid noise from being displayed on the screen during the corresponding transition period, black data may be displayed during the transition period.

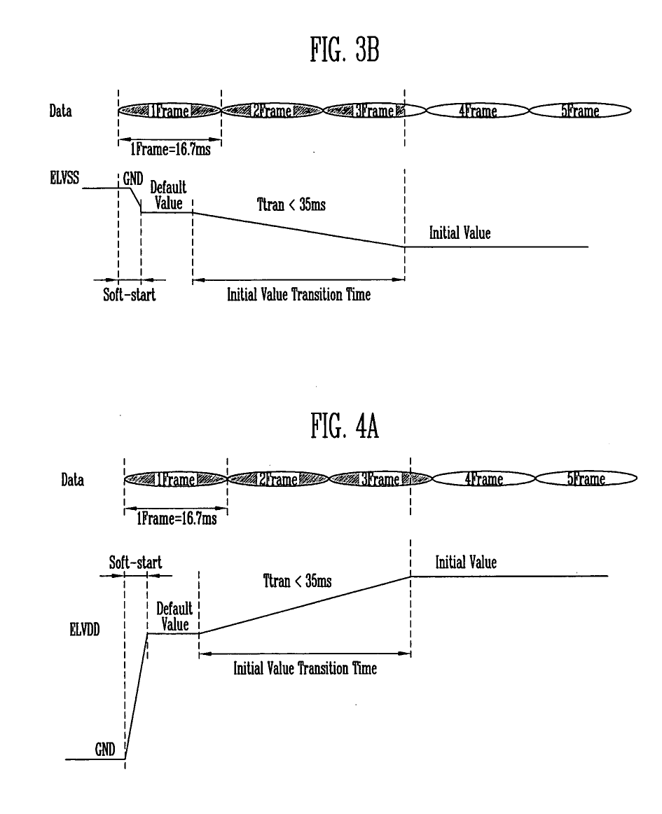

FIGS. 3A and 3B illustrate diagrams of exemplary driving methods for adjusting the second power source ELVSS voltage level. In FIGS. 3A and 3B, the driving frequency of 60 Hz, that is, the period of one frame is realized as 16.7 ms.

Referring to FIG. 3A, the input voltage, e.g., GND, may be driven by the second power source ELVSS having the previously set voltage level, e.g., the default value, the first level, etc., through the soft start operation and may be adjusted into the second power source ELVSS having the new voltage level, e.g., the initial value, the second level, etc.

In the exemplary embodiment of FIG. 3A, an absolute value of the first level is larger than the absolute value of the second level. For example, the first level may be −5.4V and the second level may be −4.9V.

Referring to FIG. 3A, the soft start period and the time period during which the first level is applied may be included during a first frame, i.e., within 16.7 ms after the power source of the organic light emitting display is applied first. Black data may be applied to the pixel unit during the first frame.

As described above, the transition time during which the first level is adjusted into the second level may not be completely controlled. When the transition time is short, noise may be displayed on the screen. For example, in some embodiments, when the transition time is about 35 ms or less, black data may be applied during the transition period. Thus, as discussed above, black data may be applied during the period during which the transition takes place, e.g., during the second and third frame time (33.4 ms) to prevent noise from being displayed on the screen.

When the transition time is long, noise may not be displayed on the screen as a result of, e.g., the voltage adjustment. However, in some embodiments, black data may be applied during continuous frames, e.g., three continuous frames, corresponding to the transition period for adjusting the voltage to the second level from the first level.

Embodiments may prevent deterioration of picture quality by adjusting the voltage of driving power sources.

In the exemplary embodiment of FIG. 3B, the absolute value of the first level is smaller than the absolute value of the second level. For example, the first level may be −4.5V and the second level may be −4.9V.

In the exemplary embodiment of FIG. 3B, the transition time is shorter than the transition time of the exemplary embodiment of FIG. 3A. Referring to FIG. 3B, since the transition time is shorter than the period when the black data is applied, it is possible to prevent/reduce picture quality from deteriorating during adjustment of the voltage level(s) of the driving power sources. More particularly, in the exemplary embodiment of FIG. 3B, the transition time is shorter than the three continuous frames during which black data is applied.

In the exemplary embodiment of FIG. 3A, the default value is shown to be less than both the initial value and the input voltage, e.g., GND, while in the exemplary embodiment of FIG. 3B, the default value is greater than the initial value and less than the input voltage, e.g., GND. Referring to FIG. 3B, the input voltage, e.g., GND, is driven through the soft start operation to be adjusted to the second power source having the second level, e.g., the initial value. During the transition time when the input voltage is transitioned to the adjusted voltage of the second power source ELVSS, black data may be displayed, e.g., black frame.

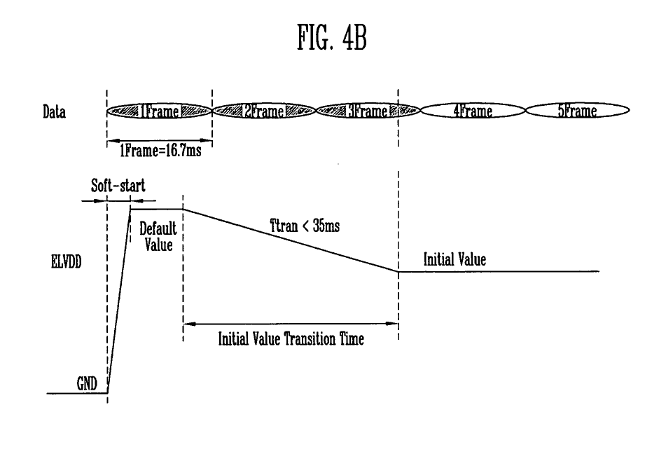

FIGS. 4A and 4B illustrate diagrams of exemplary driving methods for adjusting the first power source ELVDD voltage level. In FIGS. 4A and 4B, like in FIGS. 3A and 3B, the driving frequency is 60 Hz and one frame is realized as 16.7 ms.

Referring to FIG. 4A, the input voltage, e.g., GND, may be driven by the first power source ELVDD having the previously set voltage level, e.g., the default value, the first level, etc., through the soft start operation and may be adjusted to the second power source ELVDD having the new voltage level, e.g., the initial value, the second level, etc.

In the exemplary embodiment of FIG. 4A, the absolute value of the second level, e.g., 5.0V, is larger than the absolute value of the first level, e.g., 4.6V. In this case, the time corresponding to the soft start period and the period in which the first level is applied is included in the first frame after the power source of the organic light emitting display is applied first, e.g., within 16.7 ms. During the first frame, the black data may be applied to the pixel unit.

As described above, the transition time when the first level is adjusted into the second level may not be completely controlled. In some embodiments, when the transition time is short, e.g., within about 35 ms, noise may be displayed on the screen. Thus, in such embodiments, during the period corresponding to 35 ms, e.g., for the second and third frame time (33.4 ms), black data may be applied.

When the transition time is long, noise may not be displayed on the screen as a result of, e.g., the voltage adjustment. However, in some embodiments, black data may be applied during continuous frames, e.g., three continuous frames, corresponding to the transition period for adjusting the voltage to the second level from the first level.

Embodiments may prevent deterioration of picture quality by adjusting the voltage of one or more of the driving power sources and/or by displaying black data during the transition period.

In the exemplary embodiment of FIG. 4B, the absolute value of the first level, e.g., 5.4V, is larger than the absolute value of the second level, e.g., 5V.

In this case, the transition time may be shorter than the transition time of the exemplary embodiment of FIG. 4A. However, referring to FIGS. 4A and 4B, when, e.g., black data is applied in during continuous frames corresponding to a time period greater than or equal to the transition period, e.g., three continuous frames, it is possible to prevent and/or reduce picture quality from deteriorating during adjustment of the driving power source voltages.

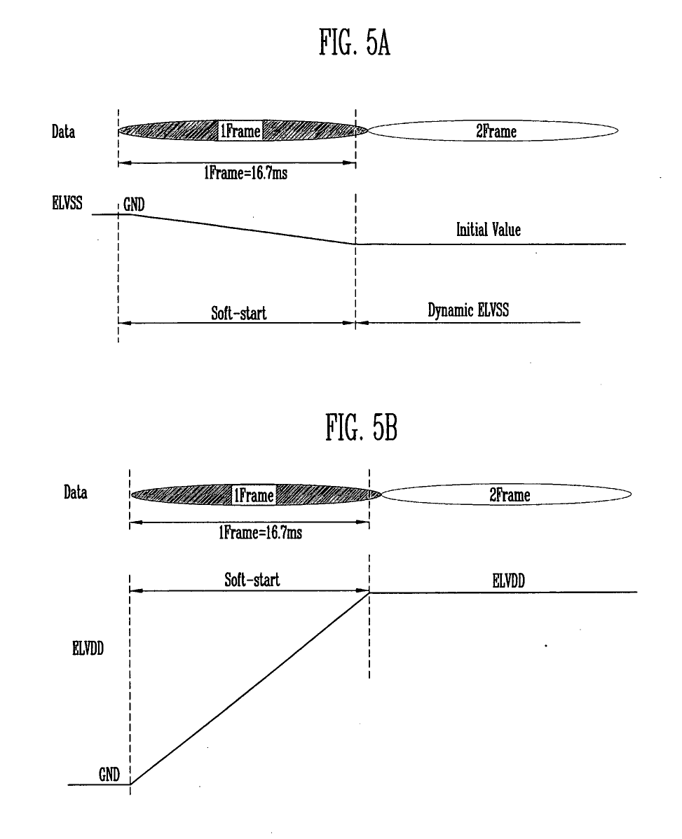

FIG. 5A illustrates a diagram of another exemplary of embodiment a driving method when the second power source ELVSS is adjusted. FIG. 5A is different from FIGS. 3A and 3B in that a ground power source GND is not changed into the first level, e.g., the default value, but into the second level, e.g., the initial value, through soft start. At this time, when the time during which the ground power source GND is adjusted to the second level through the soft start is controlled so that the voltage of the second power source ELVSS is adjusted from the ground power source GND into the second level, e.g., the initial value, the voltage of the second power source ELVSS may be at the initial value in a shorter period of time as compared to, e.g., the exemplary embodiment of FIG. 3A. Thus, in such embodiments, e.g., the time during which black data is input at initial driving stage may be reduced.

FIG. 5B illustrates a diagram of another exemplary embodiment of a driving method when the first power source ELVDD is adjusted. FIG. 5B is different from FIGS. 4A and 4B in that the ground power source GND is not changed into the first level, e.g., the default value, but into the second level, e.g., the initial value, through the soft start. At this time, when the time during which the ground power source GND is adjusted to the second level, e.g., the initial value, through the soft start is controlled so that the voltage of the first power source ELVDD is adjusted from the ground power source (GND) into the second level, e.g., the initial value, the voltage of the of the first power source ELVDD may be adjusted to the initial value in a shorter period of time as compared to, e.g., the exemplary embodiment of FIG. 4A. Thus, in such embodiments, e.g., the time during which black data is input at the initial driving stage may be reduced.

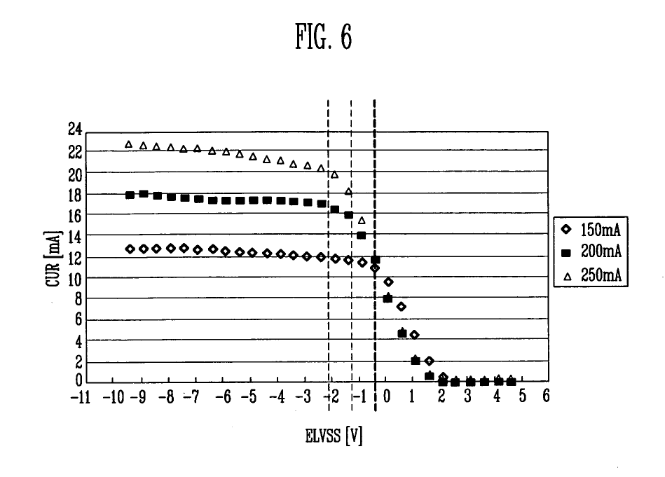

FIG. 6 illustrates a graph of a relationship between current and voltage of an organic light emitting diode, including saturation point of time in accordance with a change in the amount of current of an organic light emitting diode (OLED).

The horizontal axis of the graph illustrates a voltage of a base power source ELVSS coupled to a cathode electrode of the OLED. The vertical axis of the graph illustrates an amount of current that flows from an anode electrode to the cathode electrode of the OLED.

Referring to FIG. 6, when saturation current is 150 mA, the voltage of the cathode electrode at the point that reaches a saturation region is between 0V to −1V. When the saturation current is 200 mA, the voltage of the cathode electrode at the point that reaches the saturation region is between −1 and −2. When the saturation current is 250 mA, the voltage of the cathode electrode at the point that reaches the saturation region is lower than −2V. That is, the voltage of the cathode electrode varies with the amount of the saturation current.

In addition, the saturation region may change in accordance with the organic layer material of the OLED and the characteristic of the driving transistor included in each of the pixels of the display. Therefore, in order to prevent and/or reduce a reduction in picture quality, an organic light emitting display device may be designed to have a larger voltage level margin for the first and/or second power sources thereof. For example, in view of the conditions shown in FIG. 6, the second power source ELVSS may be designed to have a voltage level margin of about 2V or 3V.

The base power source ELVSS coupled to the cathode electrode in the organic light emitting display may be fixed to a voltage, e.g., −5.4V, lower than a voltage corresponding to the case in which the saturation current is largest, in accordance with variables other than an amount of saturation current, e.g., temperature. However, when the base power source is fixed to the lowermost voltage to be applied, a driving voltage is wasted and power consumption may increase.

Embodiments employing one or more features described herein may provide an organic light emitting display device in which driving power sources are adjusted such that power consumption may be reduced.

Embodiments employing one or more features described herein may provide an organic light emitting display device in which black data is displayed during a driving power source transition time so that it is possible to reduce and/or eliminate picture quality deterioration.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
a pixel unit including pixels coupled to scan lines and data lines;
a DC-DC converter for transmitting a voltage level of at least one power source of a first power source and a second power source to provide the power source to the pixel unit; and
a voltage controller for controlling a voltage level transition time of the DC-DC converter.

2. The organic light emitting display as claimed in claim 1, wherein the first power source has a high level voltage value.

3. The organic light emitting display as claimed in claim 1, wherein the first power source is applied as a predetermined first level voltage value and is adjusted into a second level voltage value after a time controlled by the voltage controller.

4. The organic light emitting display as claimed in claim 1, wherein the second power source has a low level voltage value.

5. The organic light emitting display as claimed in claim 1, wherein the second power source is applied as a predetermined first level voltage value and is adjusted to a second level voltage value after a time controlled by the voltage controller.

6. The organic light emitting display as claimed in claim 1, wherein the first power source reaches a second level voltage value by the voltage controller at a time when the DC-DC converter is turned on.

7. The organic light emitting display as claimed in claim 1, wherein the second power source reaches a second level voltage value by the voltage controller at the time when the DC-DC converter is turned on.

8. The organic light emitting display as claimed in claim 1, wherein the DC-DC converter includes:
first and second coils;
first and second switching elements adapted to control current to and/or from the first and second coils, respectively;
a reference voltage transition circuit adapted to adjust a reference voltage level;
a pulse-width modulated (PWM) controller adapted to control switching operations of the first and second switching elements; and
first and second resistors coupled between the first reference voltage transition circuit and the second coil.

9. The organic light emitting display device as claimed in claim 8, wherein the first switching element is adapted to transmit input current to the first coil to control generation of electromotive force by the first coil.

10. The organic light emitting display device as claimed in claim 9, wherein the PWM controller includes a lookup table in which a voltage correction range of the reference voltage level corresponding to the voltage level of the input current is provided.

11. The organic light emitting display device as claimed in claim 8, wherein the first switching element and the second switching element are coupled in parallel.

12. The organic light emitting display device as claimed in claim 8, wherein the PWM controller is coupled between the first and second resistors and the reference voltage transition circuit.

13. A method of driving an organic light emitting display, comprising:
adjusting an input voltage into a predetermined first voltage level of a driving power source;
adjusting the first level voltage of the driving power source to a second level voltage, wherein the second level voltage reaches a steady state; and
applying black data to a pixel unit during a time period when the first level voltage is being adjusted to the second level voltage.

14. The method as claimed in claim 13, wherein the driving power source is a high level first power source.

15. The method as claimed in claim 13, wherein the driving power source is a low level second power source.

16. The method as claimed in claim 13, wherein an absolute value of the second level voltage value is larger than an absolute value of the first level voltage value.

17. The method as claimed in claim 13, wherein applying black data includes applying black data to the pixel unit during each frame period during which adjusting the first level voltage of the driving power source to the second level voltage takes place.

18. The method as claimed in claim 17, wherein applying black data includes applying black data during three continuous frame periods.

19. The method as claimed in claim 17, wherein a driving frequency of the frame is 60 Hz.

20. A method of driving an organic light emitting display, comprising:
adjusting an input voltage into an initial voltage level of a driving power source, the initial level voltage reaching a steady state; and
applying black data to a pixel unit during a frame period during which the input voltage is adjusted into the initial voltage level.
